(19) United States
(12) Patent Application Publication
(10) Pub. No.: US 2023/0102544 A1
(43) Pub. Date: Mar. 30, 2023

(54) CONTRASTIVE BEHAVIORAL SIMILARITY EMBEDDINGS FOR GENERALIZATION IN REINFORCEMENT LEARNING

(71) Applicant: Google LLC, Mountain View, CA (US)

(72) Inventors: Rishabh Agarwal, Montreal (CA); Marlos Cholodovskis Machado, Edmonton (CA); Pablo Samuel Castro Rivadeneira, Ottawa (CA); Marc Gendron-Bellemare, Montreal (CA)

(21) Appl. No.: 17/487,769

(22) Filed: Sep. 28, 2021

(51) Int. Cl. G06N 3/08; G06N 3/04

(52) U.S. Cl. CPC G06N 3/08; G06N 3/0454

(57) ABSTRACT

Approaches are described for training an action selection neural network system for use in controlling an agent interacting with an environment to perform a task, using a contrastive loss function based on a policy similarity metric. In one aspect, a method includes: obtaining a first observation of a first training environment; obtaining a plurality of second observations of a second training environment; for each second observation, determining a respective policy similarity metric between the second observation and the first observation; processing the first observation and the second observations using the representation neural network to generate a first representation of the first training observation and a respective second representation of each second training observation; and training the representation neural network on a contrastive loss function computed using the policy similarity metrics and the first and second representations.

### BACKGROUND

This specification relates to controlling agents using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a nonlinear transformation to a received input to generate an output.

### SUMMARY

This specification describes a system implemented as computer programs on one or more computers in one or more locations that trains an action selection neural network system that is used to control an agent.

The subject matter described in this specification can be implemented in particular embodiments so as to realize one or more of the following advantages.

One way to improve controlling agents using machine learning models is to train the policy neural network that generates the policy output to be generalizable across different environments. For example, a policy output for controlling an agent trying to jump over an obstacle trained using observations from an environment consisting of a wide grid may not be generalizable to an environment consisting of a narrow grid when the policy neural network is trained using conventional techniques.

For example, some existing methods for learning representations that are provided as input to the policy neural network can result in overly restrictive or permissive policies and thus poor generalization. This specification, on the other hand, discloses techniques that make use of a contrastive loss function based on a policy similarity metric that considers both local and long-term behaviors by the agent, resulting in representations and, therefore, policy outputs that generalize across different environments.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example action selection system.

FIG. 2 shows an example training system.

FIG. 3 shows an example of two similar observations based on a policy similarity metric (PSM).

FIG. 4 shows an example architecture.

FIG. 5 is a flow diagram of an example process for training an action selection system.

Like reference numbers and designations in the various drawings indicate like elements.

### DETAILED DESCRIPTION

This specification describes approaches for training an action selection (neural network) system.

The action selection system includes a representation neural network and a policy neural network.

The representation neural network is configured to receive an observation of an environment and to process the observation to generate a representation of the observation.

The policy neural network is configured to receive the representation and to generate a policy output that defines an action to be performed by the agent in response to the observation.

Specifically, during the training, the system computes a policy similarity metric between two observations, each from a different training environment, and uses a contrastive loss function that is based on the policy similarity metric to train the representation neural network, e.g., while also training the policy neural network and the representation neural network through reinforcement learning or imitation learning. Training the representation neural network using the contrastive loss function enables the policy output to be generalizable across different environments.

In some implementations, the environment is a real-world environment and the agent is a mechanical agent interacting with the real-world environment. For example, the agent may be a robot interacting with the environment to accomplish a specific task, e.g., to locate an object of interest in the environment or to move an object of interest to a specified location in the environment or to navigate to a specified destination in the environment; or the agent may be an autonomous or semi-autonomous land or air or sea vehicle navigating through the environment.

In these implementations, the observations may include, for example, one or more of images, object position data, and sensor data to capture observations as the agent as it interacts with the environment, for example sensor data from an image, distance, or position sensor or from an actuator.

For example, in the case of a robot, the observations may include data characterizing the current state of the robot, e.g., one or more of: joint position, joint velocity, joint force, torque or acceleration, for example gravity-compensated torque feedback, and global or relative pose of an item held by the robot.

In the case of a robot or other mechanical agent or vehicle, the observations may similarly include one or more of the position, linear or angular velocity, force, torque or acceleration, and global or relative pose of one or more parts of the agent. The observations may be defined in 1, 2 or 3 dimensions, and may be absolute and/or relative observations.

The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In the case of an electronic agent, the observations may include data from one or more sensors monitoring part of a plant or service facility such as current, voltage, power, temperature and other sensors and/or electronic signals representing the functioning of electronic and/or mechanical items of equipment.

In these implementations, the actions may be control inputs to control the robot, e.g., torques for the joints of the robot or higher-level control commands, or the autonomous or semi-autonomous land or air or sea vehicle, e.g., torques to the control surface or other control elements of the vehicle or higher-level control commands.

In other words, the actions can include for example, position, velocity, or force/torque/acceleration data for one or more joints of a robot or parts of another mechanical agent. Action data may additionally or alternatively include electronic control data such as motor control data, or more generally data for controlling one or more electronic devices within the environment the control of which has an effect on the observed state of the environment. For example in the case of an autonomous or semi-autonomous land or air or sea vehicle, the actions may include actions to control navigation such as steering, and movement, e.g., braking and/or acceleration of the vehicle.

In some implementations, the environment is a simulated environment and the agent is implemented as one or more computers interacting with the simulated environment. Training an agent in a simulated environment may enable the agent to learn from large amounts of simulated training data while avoiding risks associated with training the agent in a real world environment, e.g., damage to the agent due to performing poorly chosen actions. An agent trained in a simulated environment may thereafter be deployed in a real-world environment.

For example, the simulated environment may be a simulation of a robot or vehicle and the reinforcement learning system may be trained on the simulation. For example, the simulated environment may be a motion simulation environment, e.g., a driving simulation or a flight simulation, and the agent is a simulated vehicle navigating through the motion simulation. In these implementations, the actions may be control inputs to control the simulated user or simulated vehicle.

In another example, the simulated environment may be a video game and the agent may be a simulated user playing the video game.

In a further example, the environment may be a chemical synthesis or a protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that performs or controls the protein folding actions selected by the system automatically without human interaction. The observations may include direct or indirect observations of a state of the protein and/or may be derived from simulation.

In a similar way the environment may be a drug design environment such that each state is a respective state of a potential pharma chemical drug and the agent is a computer system for determining elements of the pharma chemical drug and/or a synthetic pathway for the pharma chemical drug. The drug/synthesis may be designed based on a reward derived from a target for the drug, for example in simulation. As another example, the agent may be a mechanical agent that performs or controls synthesis of the drug.

In some applications, the agent may be a static or mobile software agent i.e., a computer programs configured to operate autonomously and/or with other software agents or people to perform a task. For example, the environment may be an integrated circuit routing environment and the system may be configured to learn to perform a routing task for routing interconnection lines of an integrated circuit such as an ASIC. The rewards (or costs) may then be dependent on one or more routing metrics such as an interconnect resistance, capacitance, impedance, loss, speed or propagation delay, physical line parameters such as width, thickness or geometry, and design rules. The observations may be observations of component positions and interconnections; the actions may comprise component placing actions, e.g., to define a component position or orientation and/or interconnect routing actions, e.g., interconnect selection and/or placement actions. The routing task may thus comprise placing components i.e., determining positions and/or orientations of components of the integrated circuit, and/or determining a routing of interconnections between the components. Once the routing task has been completed an integrated circuit, e.g., ASIC, may be fabricated according to the determined placement and/or routing. In some implementations, the environment may be a data packet communications network environment, and the agent be a router to route packets of data over the communications network based on observations of the network.

Generally, in the case of a simulated environment, the observations may include simulated versions of one or more of the previously described observations or types of observations and the actions may include simulated versions of one or more of the previously described actions or types of actions.

In some other applications, the agent may control actions in a real-world environment including items of equipment, for example in a data center or grid mains power or water distribution system, or in a manufacturing plant or service facility. The observations may then relate to operation of the plant or facility. For example, the observations may include observations of power or water usage by equipment, or observations of power generation or distribution control, or observations of usage of a resource or of waste production. The agent may control actions in the environment to increase efficiency, for example by reducing resource usage, and/or reduce the environmental impact of operations in the environment, for example by reducing waste. The actions may include actions controlling or imposing operating conditions on items of equipment of the plant/facility, and/or actions that result in changes to settings in the operation of the plant/facility e.g., to adjust or turn on/off components of the plant/facility.

In some further applications, the environment is a real-world environment and the agent manages distribution of tasks across computing resources e.g., on a mobile device and/or in a data center. In these implementations, the actions may include assigning tasks to particular computing resources.

As further example, the actions may include presenting advertisements, the observations may include advertisement impressions or a click-through count or rate, and the reward may characterize previous selections of items or content taken by one or more users.

In general, in the above described applications, where the environment is a simulated version of a real-world environment, once the system/method has been trained in the simulation it may afterwards be applied to the real-world environment. That is, control signals generated by the system/method may be used to control the agent to perform a task in the real-world environment in response to observations from the real-world environment. Optionally the system/method may continue training in the real-world environment based on one or more rewards from the real-world environment.

Optionally, in any of the above implementations, the observation at any given time step may include data from a previous time step that may be beneficial in characterizing the environment, e.g., the action performed at the previous time step, the reward received at the previous time step, and so on.

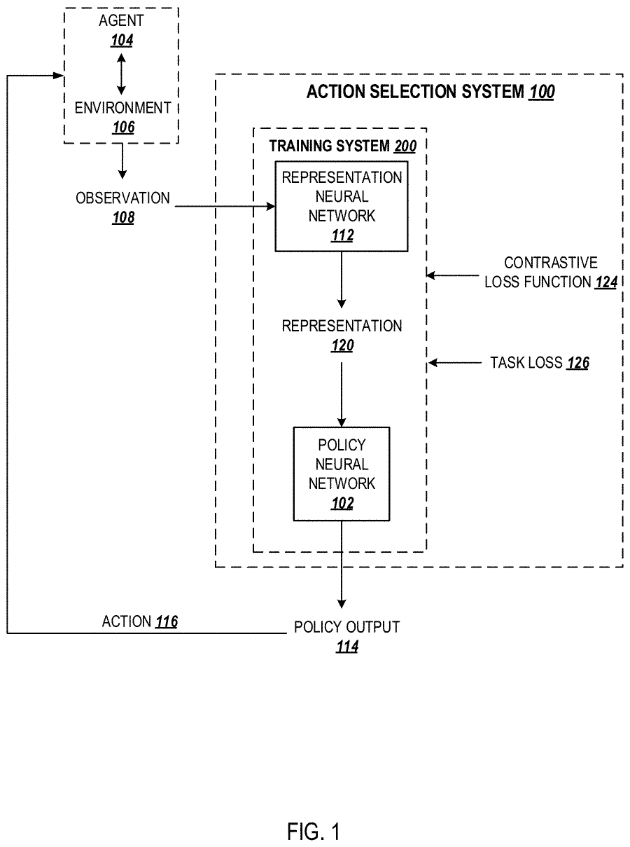

FIG. 1 shows an example action selection system 100. The action selection system 100 is an example of a system implemented as computer programs on one or more computers in one or more locations in which the systems, components, and techniques described below are implemented.

The action selection system 100 includes a representation neural network 112 and a policy neural network 102. The representation neural network 112 is configured to receive an observation 108 and generates a representation 120 of the observation 108. Each input to the representation neural network 112 can include the observation 108 characterizing the state of the environment 106 being interacted with by the agent 104.

The output of the representation neural network 112 (“representation” 120) is provided as an input to the policy neural network 102.

The output of the policy neural network (“policy output” 114) can define an action 116 to be performed by the agent 104 in response to the observation 108.

As a particular example, the policy output 114 of the policy neural network 102 can be a respective Q value for each action in the set of actions that represents a predicted return that would be received by the agent as a result of performing the action in response to the observation. The system 100 can then control the agent 104 based on the Q values for the actions in the set of actions, e.g., by selecting, as the action to be performed by the agent 104, the action with the highest Q value.

As another particular example, each input to the representation neural network 112 can be an observation, and the policy output 114 of the policy neural network 102 can be a probability distribution over the set of actions, with the probability for each action representing the likelihood that performing the action in response to the observation will maximize the predicted return. The system 100 can then control the agent 104 based on the probabilities, e.g., by selecting, as the action to be performed by the agent 104, the action with the highest probability or by sampling an action from the probability distribution.

In some cases, in order to allow for fine-grained control of the agent, the system 100 can treat the space of actions to be performed by the agent, i.e., the set of possible control inputs, as a continuous space. Such settings are referred to as continuous control settings. In these cases, the policy output 114 of the policy neural network 102 can be the parameters of a multi-variate probability distribution over the space, e.g., the means and covariances of a multi-variate Normal distribution.

The action selection (neural network) system 100 can be trained by a training system 200.

The training system 200 trains the action selection system 100 to generate policy outputs 114 that are generalizable across multiple environments or to new environment. That is, the training system 200 trains the action selection system 100 so that the policy outputs can be used to perform the same or similar tasks in multiple different environments, e.g., environments in which objects that are relevant to the task have different properties or configurations, environments in which objects that are not relevant to the task and must be ignored by the agent are located at different places, environments with different distances between objects, different weather conditions, or any other differences that can make performing the same task challenging for a policy that does not generalize well.

For example, a factory robot (agent in this example) in a manufacturing plant can perform the same task (e.g., assembling components) in different assembly lines, e.g., each assembly line corresponding to assembling components with different specifications or each assembly line having somewhat different characteristics, e.g., different speeds or different physical dimensions. In this example, different assembly lines are different environments, and the goal is to train the action selection system to control the factory robot so that it can be used to perform the task across multiple different assembly lines.

In particular, the system 200 trains the action selection system 100 across multiple environments that have differences in some or all of the above-described aspects. The environment 106, i.e., an environment in which the action selection system 100 will be used after training to control an agent, can be one of the multiple environment or, after training, the system 100 can be used to control the agent in a new environment 106 that was not one of the multiple environments used during training.

During training, for each the multiple environments, the training system 200 generates trajectories, with each trajectory being a sequence of observations received while the agent interacts with the environment while being controlled by an expert policy for the environment.

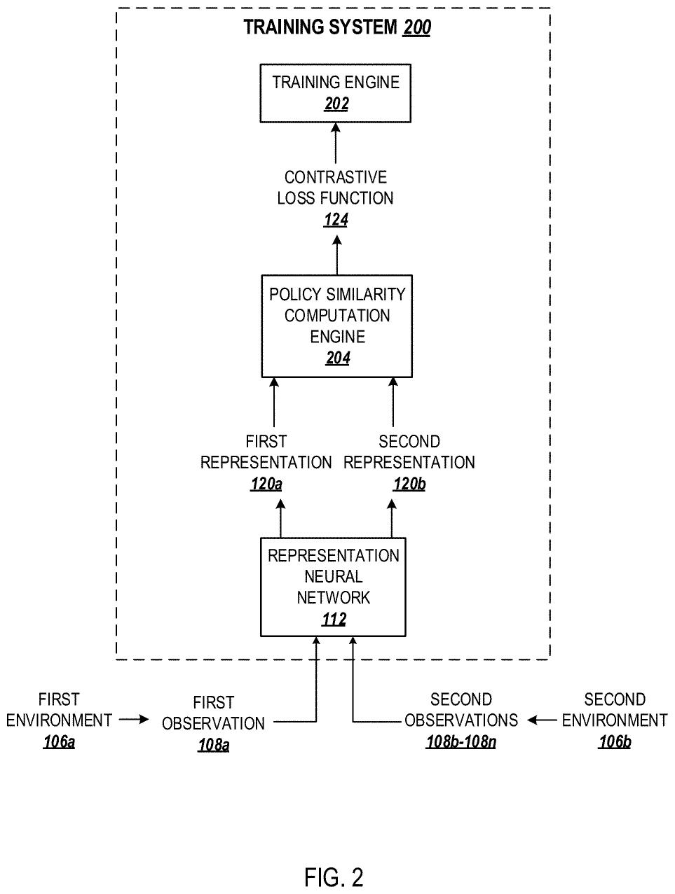

In some implementations, the training system 200 trains both the representation neural network 112 and the policy neural network 102 end-to-end jointly (e.g., to learn the policy output 114 that generalizes), e.g., by using a task loss 126 (e.g., based on received rewards from the reinforcement learning) in conjunction with a contrastive loss function 124 using the generated trajectories. The contrastive loss function 124 is based on a policy similarity metric between observations across environments (described in more details referring to FIG. 2). In some of these implementations, the system 200 backpropagates gradients of the task loss into the representation neural network 112, i.e., so that the network 112 is trained using both the task loss and the contrastive loss. In others of these implementations, the system 200 only trains the neural network 112 on the contrastive loss while training the policy neural network 102 on the task loss. The task loss 126 measures a performance of the policy neural network 102 in performing a specified task.

In some implementations, the training system 200 pre-trains the representation neural network 112 on the contrastive loss function 124 (on some other environments other than the environment 106) and the trains the policy neural network 102 on the environment 106 using the task loss 126.

In some implementations, the training system 200 pre-trains the policy neural network 102, and during the training the representation neural network 112, the training system fine-tunes the policy neural network 102 based on the output of the representation neural network 112.

FIG. 2 shows an example training system 200. The training system 200 is an example of a system implemented as computer programs on one or more computers in one or more locations in which the systems, components, and techniques described below are implemented.

As described above, the training system 200 is configured to train the representation neural network 112 on the contrastive loss function 124 using trajectories from multiple environments. Additionally, as described above, in some implementations, during this training, the system 200 also trains the neural network 112 using gradients of a task loss that are backpropagated through the policy neural network 102.

In particular, at each training iteration, the system 200 identifies a pair of environments that includes a first environment 106a and a second environment 106b. When there are more than two environments in the set of multiple environments, the system can sample the environments 106a and 106b randomly from the set.

The training system 200 receives a set of observations, e.g., a first observation 108a from the first environment 106a and a set of second observations 108b-108n from a second environment 106b.

A training engine 202 generates a respective trajectory for each observation. Each trajectory includes a respective future observation at each of one or more next time steps, if the agent were controlled to act in the corresponding environment starting from the observation (e.g., first observation, second observation) using an expert policy. Each environment is associated with a respective expert policy for controlling the agent in the environment; for example, the first environment 106a is associated with a first expert policy, and the second environment 106b is associated with a second expert policy.

The expert policy for a given environment, e.g., the first expert policy and the second expert policy, is an optimal policy output, either known and provided as input to the system or approximated by the system. For example, the optimal policy for a given environment can be approximated by an action selection neural network that has been trained using only trajectories from that given environment, i.e., without concern for whether the policy output generated by the action selection neural network will generalize to other environments.

The training system 200 (e.g., the representation neural network 112) receives the first observation 108a and a set of multiple second observations 108b-108n.

The representation neural network 112 generates a first representation 120a of the first (training) observation 108a and a respective second representation 120b of each of the second (training) observations 108b-108n.

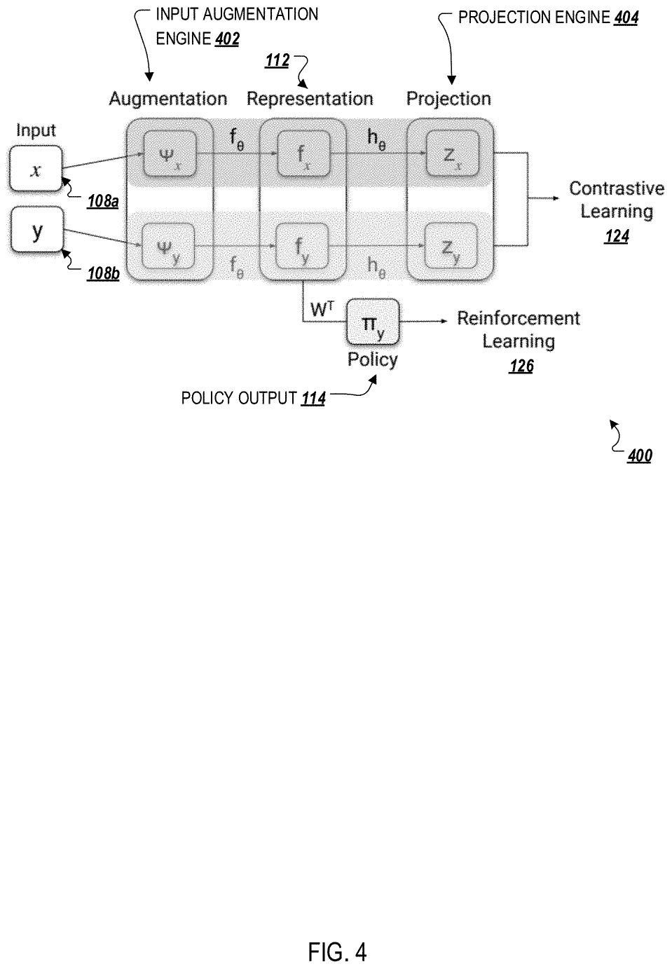

In some implementations, prior to providing the first observation and the second observations as inputs to the representation neural network 112, the system applies an input augmentation to the observations (described in more details below referring to FIG. 4).

In some implementations, a projection engine then projects the first representation 120a and the second representation 120b and generates projected representations (described in more details below referring to FIG. 4).

The training system 200 includes a policy similarity computation engine 204 that is configured to receive (projected, if the projection engine is used) representations 120a, 120b and determine a respective policy similarity metric between the first observation 108a and each of the second observations 108b-108n.

In some implementations, the respective policy metric is based on one or more of (i) a distance in a local optimal behavior based on a distance between a first policy output generated by the first expert policy of the first environment 106a (by processing the first observation 108a) and a second policy output generated by the second expert policy of the second environment 106b (by processing each of the second observations 108b-108n); and (ii) a distance in a long-term optimal behavior, for each next time step in the corresponding trajectories, based on a respective distance between a first policy output generated by the first expert policy of the first environment 106a (by processing the future first observation at the next step) and a second policy output generated by the second expert policy of the second environment 106b (by processing the future second observation at the next time step).

In some implementations, the respective policy metric is based on the sum of (i) and (ii) as described above.

The training engine 202 trains the representation neural network 112 by minimizing the contrastive loss function 124 that is based on the policy similarity metrics.

More specifically, the training engine 202 trains the representation neural network 112 on the contrastive loss function 124, by sampling a positive pair of training data and one or more negative pairs of training data based on the policy similarity metrics.

The positive pair of training data includes the first observation and a second observation that is a nearest neighbor to the first observation based on the policy similarity metric.

The negative pair of training data includes observations that are not the positive pair of training data, e.g., each remaining second observation in the set of second observations other than the nearest neighbor, a threshold number of the remaining second observations that are least similar to the first observation based on the policy similarity metric, or a randomly selected subset of the remaining second observations.

The contrastive loss function 124 penalizes a longer distance between the (projected) representations of the observations in the positive pair of training data and incentivizes longer distances between the (projected) representations of the observations in each negative pair of training data.

As one example given the positive pair (\tilde{x}_{y}, y), the set X′ containing the negative pairs, and the policy similarity metric ρ, the contrastive loss is given by the following:

$$loss ( \tilde{{x}_{y}} , y ; {𝒳}^{′} ) = - log \frac{ρ ( \tilde{{x}_{y}} , y ) exp ( λ {s}_{θ} ( \tilde{{x}_{y}} , y ) )}{ρ ( \tilde{{x}_{y}} , y ) exp ( λ {s}_{θ} ( \tilde{{x}_{y}} , y ) ) + {\sum }_{{x}^{′} ∈ {𝒳}^{′} \backslash \{ \tilde{{x}_{y}} \}} ( 1 - ρ ( {x}^{′} , y ) ) exp ( λ {s}_{θ} ( {x}^{′} , y ) )} ,$$

$$where λ$$

is an inverse temperature hyperparameter, and s_{θ}(\tilde{x}_{y}, y)=sim (z_{θ}(\tilde{x}_{y}), z_{θ}(y)) where

$$sim ( u , v ) = \frac{{u}^{T} v}{‖ u ‖ ‖ v ‖} .$$

This training scheme maximizing similarity between the positive pair while minimizing its similarity to other (negative) pairs can be referred to as a contrastive behavioral similarity embedding, because the contrastive loss function 124 embeds the policy similarity metrics.

In some implementations, the training system 200 trains both the representation neural network 112 and the policy neural network 102 on the received observations through reinforcement learning (e.g., on the task loss 126). That is, the system can use the first observations, the second observations, or both to train the policy neural network 102 on the task loss 126 and, optionally, to train the representation neural network 112 by backpropagating gradients of the task loss 126 through the policy neural network 102 and into the representation neural network 112.

For example, the task loss 126 can be an imitation learning loss using the trajectories for one or more of the first observation and the second observations. As another example, the task loss 126 is an off-policy reinforcement learning loss in the case that the trajectories include external rewards for the task. As yet another example, the task loss 126 is computed based on received rewards as a result of using the action selection system 100 to act in one or both of the environments 106a, 106b.

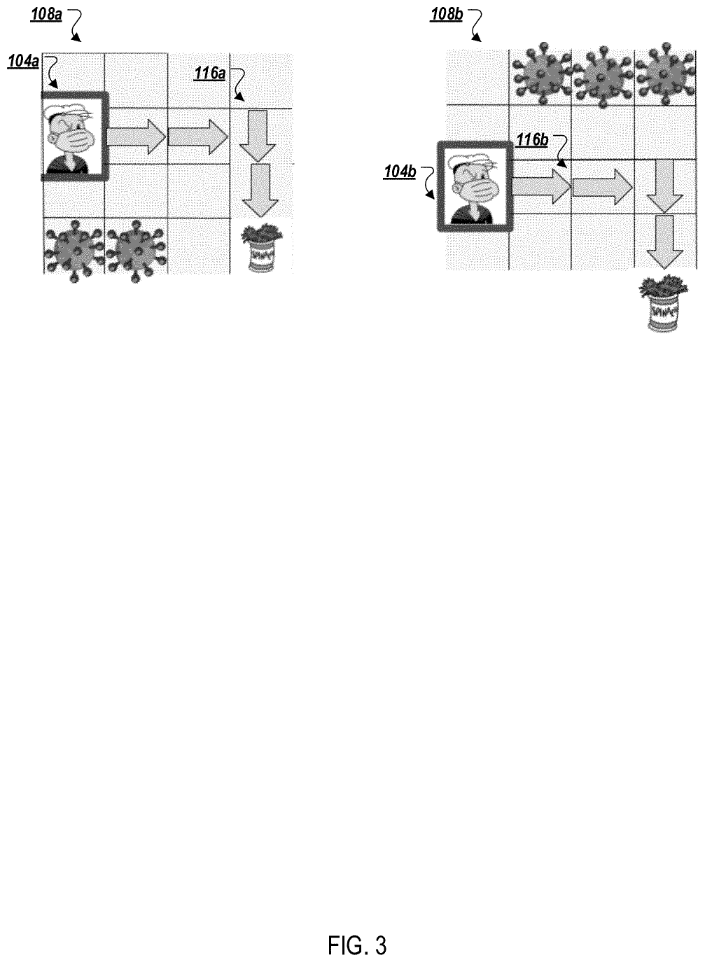

FIG. 3 shows an example of two similar observations 108a, 108b based on the policy similarity metric. The policy similarity metric quantifies a similarity between a pair of observations, e.g., a first observation 108a and a second observation 108b, based on both local and long-term optimal behaviors.

A first agent 104a is performing actions 116a while controlled using the first expert policy of the first environment. A second agent 104b (in some implementations, the same as the first agent) is performing actions 116b while controlled using the second expert policy of the second environment.

The actions 116a and 116b are similar not only in a local optimal behavior, but also in a long-term optimal behavior. That is, the first policy output of the first environment and the second policy output of the second environment are similar not only when processing the current observations in each environment but also when processing future observations that are at the same time point in the two trajectories.

FIG. 4 shows an example architecture 400. The example architecture 400 is an example configuration of training the action selection system 100 on the first observation 108a and the second observation 108b. Specifically, the architecture 400 trains the representation neural network 112 and the policy neural network 102 jointly, using both the contrastive loss function 124 and the task loss 126.

In the example architecture 400, an input augmentation engine 402 receives the first observation 108a (“x”) of the first training environment and the second observation 108b (“y”) of the second training environment as inputs. The input augmentation engine 402 modifies inputs by applying one or more augmentations (e.g., noise reduction, flip/rotate, de-colorizing) the input observations.

In some implementations, the architecture 400 does not have the input augmentation engine 402, and the representation neural network 112 receives input observations directly without any augmentation being applied. When not using data augmentation, an augmentation operator is equal to the identity operator (e.g., Ψ(x)=x).

The representation neural network 112 receives the augmented first observation and the augmented second observation and generates a first representation of the first training observation and a second representation of the second training observation.

In some implementations, the representation neural network 112 includes convolutional layers followed by a fully connected layer (e.g., 3 convolutional layers of sizes 32, 64, 64 with filter sizes 8×8, 4×4, and 3×3 followed by a single fully connected layer of size 256). For example, the representation neural network 112 applies an encoder f_{θ}; that is, fₓ=f_{θ}(Ψₓ) and f_{y}=f_{θ}(Ψ_{y}).

The first representation and the second representation are projected using a projection engine 404 h_{θ} to obtain representations zₓ and z_{y}; that is, z_{θ}(x)=h_{θ}(fₓ) and z_{θ}(y)=h_{θ}(f_{y}). The projection engine 404 is used to compute the policy similarity metrics during training, but not used after training. In some implementations, the projection engine 404 includes one or more nonlinear activation layers such as a rectified linear unit (ReLU) layer.

In some implementations, the architecture 400 does not have the projection engine 404, and the policy similarity metrics are computed on the representations.

The system determines a respective policy similarity metric between two representations.

To determine the respective policy similarity metric, the system obtains first trajectory that includes a respective future first observation at each of one or more next time steps that represents a trajectory that would be generated if the agent were controlled to act in the first environment starting from the first observation using the first expert policy.

The system obtains second trajectory that includes a respective future second observation at each of the one or more next time steps that represents a trajectory that would be generated if the agent were controlled to act in the second environment starting from the second observation using the second expert policy.

The system determines the respective policy similarity metric based on a distance between a first policy output generated by the first expert policy of the first training environment (by processing the future first observation at the next time step) and a second policy output generated by the second expert policy of the second training environment (by processing the future second observation at the next time step). For example, the policy similarity metric (d*) satisfies the following recursive equation, for a given DIST:

d*(x,y)=DIST(π*(x),π*(y))+γW₁(d*)(P^{π*}(·|x),P^{π*}(·|y)), where DIST is an absolute reward difference by a probability pseudometric between policies (e.g., when a set of actions is discrete, DIST is the total variation distance between policies; when the set of actions are continuous, DIST can be a distance between the mean actions of the two policies), π*(x) is the first expert policy, π*(y) is the second expert policy, y is a discount factor, W₁ captures long-term optimal behavior difference, and P′ indicates a transition function (from one time step to the next time step) given the expert policy.

In some implementations, the system approximates one or more of the first expert policy and the second expert policy using dynamic programming on the first observation and the plurality of second observations. For example, the recursion for the policy similarity metric takes the following form in deterministic environments:

d*(x,y)=DIST(π_{x*((x), π}_{y*(y))+γd*(x′,y′), where x′=/P}ₓ^{π*}(x), y′=P_{y}^{π*}are the next observations from taking actions π_{x*(x), π}_{y*(y) from observations x, y respectively and can be obtained from the corresponding trajectories. The equation can be solved using exact dynamic programming.}

In some implementations, the policy neural network 102 is a linear layer; that is, the policy output 114 is an affine function of the representations; that is, π_{θ}(·|y)=W^{T} f_{y}+b, where W, b are learned weights and biases.

In this example architecture, the system trains the action selection system 100 end-to-end jointly using the task loss 126 in conjunction with the contrastive loss function 124. In some implementations, the total loss function (to be used to train the policy neural network 102) is the sum of the task loss 126 and the contrastive loss function 124.

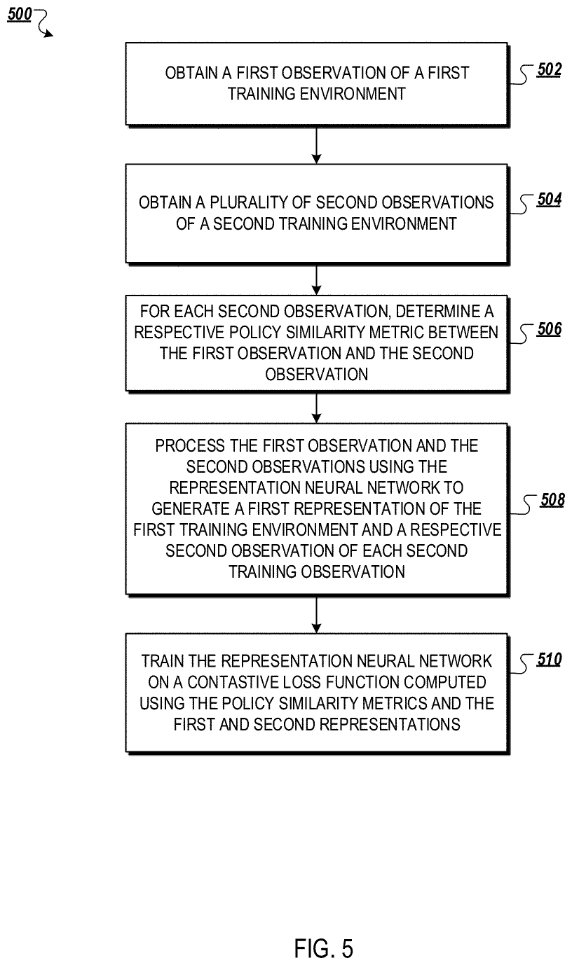

FIG. 5 is a flow diagram of an example process 500 for training an action selection neural network system using a contrastive loss function. For convenience, the process 500 will be described as being performed by a system of one or more computers located in one or more locations. For example, an action selection system, e.g., the action selection system 100 of FIG. 1, appropriately programmed, can perform the process 500.

The system obtains a first observation of a first training environment (502). The environment is a synthetic or a real world environment, each observation is the output of at least one sensor configured to sense the environment, and the agent is a mechanical agent interacting with the environment.

The system obtains a plurality of second observations of a second training environment (504).

The system, for each second observation, determines a respective policy similarity metric between the second observation and the first observation. The respective policy similarity metrics are based on a first expert policy of the first training environment and a second expert policy of the second training environment (506). To determine the respective policy similarity metrics, the system determines at least a distance in a local optimal behavior based on a distance between a first policy output generated by the first expert policy of the first training environment by processing the first observation and a second policy output generated by the second expert policy of the second training environment by processing the second observation.

In some implementations, the system obtains first trajectory that includes a respective future first observation at each of one or more next time steps that represents a trajectory that would be generated if the agent were controlled to act in the first environment starting from the first observation using the first expert policy. The system obtains second trajectory comprising a respective future second observation at each of the one or more next time steps that represents a trajectory that would be generated if the agent were controlled to act in the second environment starting from the second observation using the second expert policy. The system then also determines a distance in a long-term optimal behavior based on, for each next time step, a respective distance between a first policy output generated by the first expert policy of the first training environment by processing the future first observation at the next time step and a second policy output generated by the second expert policy of the second training environment by processing the future second observation at the next time step.

In some implementations, the system approximates one or more of the first expert policy and the second expert policy using dynamic programming on the first observation and the plurality of second observations.

The system processes the first observation and the second observations using the representation neural network to generate a first representation of the first training observation and a respective second representation of each second training observation (508). In some implementations, the system augments the first observation and the second observation by an input augmentation engine prior to providing the first observation and the second observation as inputs to the representation neural network.

In some implementations, the system generates projected representations for the first representation of the first training observation and for the respective second representations of each second training observations, e.g., by using the projection engine 404.

The system trains the representation neural network on a contrastive loss function computed using the policy similarity metrics and the first and second representations (510). The system samples a positive pair of training data based on the policy similarity metrics. The positive pair of training data includes the first observation and a second observation that is a nearest neighbor to the first observation based on the policy similarity metric. The system determines one or more negative pairs of training data. In some implementations, the system samples negative pairs of training data after excluding the positive pair of training data. The contrastive loss function penalizes a distance between the positive pair of training data and incentivizes the distance between the negative pair of training data.

In some implementations, the system trains the policy neural network on the first observation, the second observations, or both on the task loss 126 that measures a performance of the policy neural network in performing a specified task.

In some implementations, the system trains the policy neural network and the representation network on the first and second observations through reinforcement learning. For example, the system uses a task loss, e.g., reinforcement learning loss (e.g., a negative reward), in conjunction with the contrastive loss function when jointly training the policy neural network 102 and the representation network 112.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially be claimed as such, one or more features from a claimed combination can in some cases be excised from the combination, and the claimed combination can be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

What is claimed is:

1. A method for training an action selection neural network system for use in controlling an agent interacting with an environment to perform a task, the action selection neural network system comprising (i) a representation neural network configured to receive an observation of an environment and to process the observation to generate a representation of the observation and (ii) a policy neural network configured to receive the representation and to generate a policy output that defines an action to be performed by the agent in response to the observation, and the method comprising:
obtaining a first observation of a first training environment;
obtaining a plurality of second observations of a second training environment;
for each second observation, determining a respective policy similarity metric between the second observation and the first observation, wherein the respective policy similarity metrics are based on a first expert policy of the first training environment and a second expert policy of the second training environment;
processing the first observation and the second observations using the representation neural network to generate a first representation of the first training observation and a respective second representation of each second training observation; and
training the representation neural network on a contrastive loss function computed using the policy similarity metrics and the first and second representations.

2. The method of claim 1, wherein the environment is a simulated or a real world environment, each observation is the output of at least one sensor configured to sense the environment, and the agent is a mechanical agent interacting with the environment.

3. The method of claim 1, wherein processing the first observation and the second observations using the representation neural network to generate a first representation of the first training observation and a respective second representation of each second training observation comprises augmenting the first observation and the second observation by an input augmentation engine prior to providing the first observation and the second observation as inputs to the representation neural network.

4. The method of claim 1, wherein for each second observation, determining a respective policy similarity metric between the second observation and the first observation comprises:
determining a distance in a local optimal behavior based on a distance between a first policy output generated by the first expert policy of the first training environment by processing the first observation and a second policy output generated by the second expert policy of the second training environment by processing the second observation.

5. The method of claim 1, wherein for each second observation, determining a respective policy similarity metric between the second observation and the first observation comprises:
obtaining first trajectory comprising a respective future first observation at each of one or more next time steps that represents a trajectory that would be generated if the agent were controlled to act in the first environment starting from the first observation using the first expert policy;
obtaining second trajectory comprising a respective future second observation at each of the one or more next time steps that represents a trajectory that would be generated if the agent were controlled to act in the second environment starting from the second observation using the second expert policy; and
determining a distance in a long-term optimal behavior based on, for each next time step, a respective distance between a first policy output generated by the first expert policy of the first training environment by processing the future first observation at the next time step and a second policy output generated by the second expert policy of the second training environment by processing the future second observation at the next time step.

6. The method of claim 4, wherein determining a policy similarity metric further comprises approximating one or more of the first expert policy and the second expert policy using dynamic programming on the first observation and the plurality of second observations.

7. The method of claim 1, wherein training the representation neural network on a contrastive loss comprises:
sampling a positive pair of training data based on the policy similarity metrics, wherein the positive pair of training data includes the first observation and a second observation that is a nearest neighbor to the first observation based on the policy similarity metric;
determining one or more negative pairs of training data; and
training the representation neural network on the contrastive loss function that penalizes a distance between the positive pair of training data and incentivizes the distance between the negative pair of training data.

8. The method of claim 7, further comprising generating projected representations for the first representation of the first training observation and for the respective second representations of each second training observations.

9. The method of claim 7, further comprising training the policy neural network on the first observation, the second observations, or both on a task loss that measures a performance of the policy neural network in performing a specified task.

10. A system comprising:
one or more computers and one or more storage devices storing instructions that are operable, when executed by the one or more computers, to cause the one or more computers to perform operations comprising:
obtaining, at the one or more computers, a first observation of a first training environment;
obtaining, at the one or more computers, a plurality of second observations of a second training environment;
for each second observation, determining, by the one or more computers, a respective policy similarity metric between the second observation and the first observation, wherein the respective policy similarity metrics are based on a first expert policy of the first training environment and a second expert policy of the second training environment;
processing, by the one or more computers, the first observation and the second observations using the representation neural network to generate a first representation of the first training observation and a respective second representation of each second training observation; and
training, by the one or more computers, the representation neural network on a contrastive loss function computed using the policy similarity metrics and the first and second representations.

11. The system of claim 10, wherein the environment is a simulated or a real world environment, each observation is the output of at least one sensor configured to sense the environment, and the agent is a mechanical agent interacting with the environment.

12. The system of claim 10, wherein processing the first observation and the second observations using the representation neural network to generate a first representation of the first training observation and a respective second representation of each second training observation comprises augmenting the first observation and the second observation by an input augmentation engine prior to providing the first observation and the second observation as inputs to the representation neural network.

13. The system of claim 10, wherein for each second observation, determining a respective policy similarity metric between the second observation and the first observation comprises:
determining a distance in a local optimal behavior based on a distance between a first policy output generated by the first expert policy of the first training environment by processing the first observation and a second policy output generated by the second expert policy of the second training environment by processing the second observation.

14. The system of claim 10, wherein for each second observation, determining a respective policy similarity metric between the second observation and the first observation comprises:
obtaining first trajectory comprising a respective future first observation at each of one or more next time steps that represents a trajectory that would be generated if the agent were controlled to act in the first environment starting from the first observation using the first expert policy;
obtaining second trajectory comprising a respective future second observation at each of the one or more next time steps that represents a trajectory that would be generated if the agent were controlled to act in the second environment starting from the second observation using the second expert policy; and
determining a distance in a long-term optimal behavior based on, for each next time step, a respective distance between a first policy output generated by the first expert policy of the first training environment by processing the future first observation at the next time step and a second policy output generated by the second expert policy of the second training environment by processing the future second observation at the next time step.

15. The system of claim 10, wherein determining a policy similarity metric further comprises approximating one or more of the first expert policy and the second expert policy using dynamic programming on the first observation and the plurality of second observations.

16. The system of claim 10, wherein training the representation neural network on a contrastive loss comprises:
sampling a positive pair of training data based on the policy similarity metrics, wherein the positive pair of training data includes the first observation and a second observation that is a nearest neighbor to the first observation based on the policy similarity metric;
determining one or more negative pairs of training data; and
training the representation neural network on the contrastive loss function that penalizes a distance between the positive pair of training data and incentivizes the distance between the negative pair of training data.

17. The system of claim 10, further comprising generating projected representations for the first representation of the first training observation and for the respective second representations of each second training observations.

18. The system of claim 10, further comprising training the policy neural network on the first observation, the second observations, or both on a task loss that measures a performance of the policy neural network in performing a specified task.

19. A non-transitory computer-readable medium storing instructions that when executed by one or more computers cause the one or more computers to perform operations comprising:
obtaining, at the one or more computers, a first observation of a first training environment;
obtaining, at the one or more computers, a plurality of second observations of a second training environment;
for each second observation, determining, by the one or more computers, a respective policy similarity metric between the second observation and the first observation, wherein the respective policy similarity metrics are based on a first expert policy of the first training environment and a second expert policy of the second training environment;
processing, by the one or more computers, the first observation and the second observations using the representation neural network to generate a first representation of the first training observation and a respective second representation of each second training observation; and
training, by the one or more computers, the representation neural network on a contrastive loss function computed using the policy similarity metrics and the first and second representations.

20. The non-transitory computer-readable medium of claim 19, wherein training the representation neural network on a contrastive loss comprises:
sampling a positive pair of training data based on the policy similarity metrics, wherein the positive pair of training data includes the first observation and a second observation that is a nearest neighbor to the first observation based on the policy similarity metric;
determining one or more negative pairs of training data; and
training the representation neural network on the contrastive loss function that penalizes a distance between the positive pair of training data and incentivizes the distance between the negative pair of training data.
